(19) United States
(12) Patent Application Publication
(10) Pub. No.: US 2014/0100919 A1
(43) Pub. Date: Apr. 10, 2014

(54) QUALITY OF EXPERIENCE DATA COLLECTION

(71) Applicant: EMPIRE TECHNOLOGY DEVELOPMENT LLC, Wilmington, DE (US)

(72) Inventor: Louis Michael Taff, Chapel HIll, NC (US)

(73) Assignee: EMPIRE TECHNOLOGY DEVELOPMENT LLC, Wilmington, DE (US)

(21) Appl. No.: 13/810,561

(22) PCT Filed: Oct. 5, 2012
(86) PCT No.: PCT/US12/59054

§ 371 Date: Jan. 16, 2013

(51) Int. Cl. G06Q 30/02

(52) U.S. Cl. CPC G06Q 30/0203
USPC 705/7.32

(57) ABSTRACT

Technologies and implementations for providing quality of experience information are generally disclosed.

### BACKGROUND

Unless otherwise indicated herein, the approaches described in this section are not prior art to the claims in this application and are not admitted to be prior art by inclusion in this section.

Service providers (e.g., cellular network service providers), often try to evaluate the satisfaction of their customers. One way to evaluate customer satisfaction may be by gathering feedback related to customers' experiences with the service provider. Service providers often gather such feedback directly from their customers. Using data from this feedback, service providers may quantify the quality of their customer's experiences. This type of feedback data may be generally referred to as “Quality of Experience” (QoE) data. More particularly, QoE data may refer to service experiences as reported directly by customers.

Conventionally, service providers may obtain QoE data by conducting formal surveys or focus groups. However, obtaining QoE data from formal surveys and focus groups may be often expensive. Additionally there may be some delay between when an experience occurs and when QoE data related to that experience is available to the service provider. As a result, the QoE data may not be timely. Additionally, due to the delay, the QoE data may not be completely correct, as the customers may not remember their experiences accurately. Furthermore, it may often not be possible (e.g., due to expense or time constraints) to sample a very large number of customers. As such, there may not be much statistical significance to the collected QoE data.

Another method for evaluating customer satisfaction may be by trying to infer QoE from measurements of physical service parameters (e.g., received signal strength, transmit power, dropped calls, delay, jitter, or the like). These service measurements may be often referred to as Quality of Service (QoS) data. More specifically, QoS data may refer to objective measurements (e.g., by the user's device, by the service provider, or the like) of the technical characteristics of a service. However, different QoS parameters may contribute to QoE for different services. Additionally, two customers of the same service may have different perceptions of their experience though measurements of a QoS parameter are the same. As such, conventional techniques for extrapolating QoE data from QoS data are problematic and do not account for subjective judgments. Determining true QoE may still require gathering feedback directly from customers.

### SUMMARY

Detailed herein are various illustrative methods for providing quality of experience information. Example methods may include at a device, detecting an interaction with a network, recording parameters related to the detected interaction between the device and the network, generating an input form, the input form capable of receiving an indication of a quality of experience, receiving from the user at least one input based at least in part on the generated input form, and transmitting quality of service data including at least a portion of the recorded parameters and quality of experience data including the at least one received input.

The present disclosure also describes various example machine readable non-transitory media having stored therein instructions that, when executed, cause a device to provide quality of experience information. Example machine readable non-transitory media may have stored therein instructions that, when executed, cause a device to provide quality of experience data by detecting an interaction with a network, recording parameters related to the detected interaction between the device and the network, generating an input form, the input form capable of receiving an indication of a quality of experience, receiving at least one input based at least in part on the generated input form, and transmitting quality of service data including at least a portion of the recorded parameters and quality of experience data including the at least one received input.

The present disclosure additionally describes example devices for providing quality of experience information. Example devices may include a machine readable medium having stored therein instructions that, when executed, cause the device to provide quality of experience information by detecting an interaction with a network, recording parameters related to the detected interaction between the device and the network, generating an input form, the input form capable of receiving an indication of a quality of experience, receiving at least one input based at least in part on the generated input form, and transmitting quality of service data including at least a portion of the recorded parameters and quality of experience data including the at least one received input, and a processor coupled to the machine readable medium to execute the instructions.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings, understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of an example system for providing quality of experience data;

FIG. 2 illustrates a flow diagram of an example method for providing quality of experience data;

FIG. 3 illustrates a flow diagram of an example method for providing quality of experience data;

FIG. 4 illustrates a block diagram of an example form for receiving quality of experience feedback;

FIG. 5 illustrates a block diagram of an example computer program product for providing quality of experience data; and

FIG. 6 illustrates a block diagram of an example computing device for providing quality of experience data, all arranged in accordance with at least some embodiments of the present disclosure.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is drawn, inter alia, to methods, devices, systems and computer readable media related to providing quality of experience data.

Service providers (e.g., cellular network service providers, internet service providers, online banking service providers, or the like) often try to evaluate their customer's satisfaction. For example, a cellular network service provider may evaluate a customer's perception of the quality of a call, or other experience with the service provider. As indicated above, data related to these evaluations may be referred to as QoE data. Service providers use QoE data for a variety of reasons (e.g., to improve their service, to address negative customer perceptions, or the like). Conventional techniques for gathering QoE data (e.g., performing customer surveys, holding focus groups, or the like) may be typically expensive and time consuming. Furthermore, the number of customers that a service provider may sample may be often times too small (e.g., due to cost, due to time constraints, or the like) to provide a statistically significant sample.

For example, customers of a cellular network service provider may use a number of devices (e.g., a cellular telephone, a smart phone, a tablet computer, a laptop computer, an access point, or the like) to interact (e.g., make voice calls, send text messages, access data services, or the like) with the network. Customers may repeatedly have the same interaction (e.g., making a voice call) on a daily, weekly, or monthly basis. As can be appreciated, a formal survey for each customer for feedback related to these various interactions may not be practical. Particularly, the surveys may become intrusive to the customers and may eventually affect their perceived experience with the cellular network.

Additionally, there may be some delay between when a customer has an experience with the service provider and when the service provider receives feedback (e.g., in the form of QoE data) related to the experience. Accordingly, this delay may prevent the service provider from using the QoE data to remedy negative customer experiences in a timely way.

Another way service providers may attempt to gather QoE data may be by inferring QoE data from measured performance parameters (e.g., received signal strength, transmit power, call drop, delay, blocking, jitter, available bandwidth, echo, or the like) related to an interaction with the service. Service providers may use network level techniques (e.g., deep packet inspection, network congestion, or the like) to measure performance parameters. In some examples, a device (e.g., a cell phone, a computer, or the like) connecting to the network may measure performance parameters as it connects to the network. As stated above, these measured performance parameters are often referred to as QoS data.

Service providers may use QoS data to infer QoE data. However, as stated, QoE data may often be dependent upon individual customer perceptions. As such, inferring QoE data directly from QoS data may not correlate to a customer's actual perception of the service experience. Particularly, different parameters of QoS data may contribute to customer's perceived experiences for different services. Using the cellular network service introduced above as an example, a customer's experience using “real-time” services (e.g., streaming media, video chatting, or the like) over the network may be affected by jitter, while the experience of using other services (e.g., web browsing, texting, or the like) may not be affected by jitter. Additionally, two customers may have different perceptions of the same phenomenon that a particular QoS parameter measures. For example, a detected level of echo may cause one customer to have a negative experience making a voice call while the same level of echo may not cause another customer to have a negative experience making a similar voice call.

As stated above, various implementations of the disclosed subject matter may provide for the collection of QoE data. The following non-limiting example, which uses the cellular network introduced above, is given here as an overview of various illustrative embodiments that will be described in greater detail herein. As introduced above, a device (e.g., a smart phone, a tablet computer, or the like) may connect to the cellular network and access services (e.g., make calls, send/receive text messages, access data services, or the like). Accordingly, in some embodiments disclosed herein, an application executing on a device (e.g., a smart phone) may record QoS data while a customer accesses services (e.g., makes a phone call) using the smart phone and the cellular network. When the phone call is complete, the application may request the customer for an evaluation of the customer's experience. The application may do this through various methods designed to minimize the intrusiveness previously mentioned. One such method is to generate an input form capable of receiving an indication of the customer's perceived experience making the phone call. For example, the application may generate an input form with a slider to indicate a level of satisfaction. The application may then display the input form on the smart phone, allowing the customer to select a level of satisfaction using the slider. The application may then transmit the recorded QoS data and the received input from the customer to the cellular network service provider.

As stated, the foregoing example is provided for illustrative purposes only and is not intended to be limiting. Additionally, it is to be appreciated that although this example and other examples disclosed herein are given with respect to a cellular network service provider, various implementations of the present disclosure may be applied to other service providers (e.g., an internet service provider, a satellite television service provider, an online banking service provider, or the like). Additionally, with some embodiments of the present disclosure, QoE data related to access of other services (e.g., applications executing on a network device, Internet address access, or the like) through the network may be gathered. For example, various embodiments of the present disclosure may be provided to gather QoE data related to interactions with an online store over a cellular network.

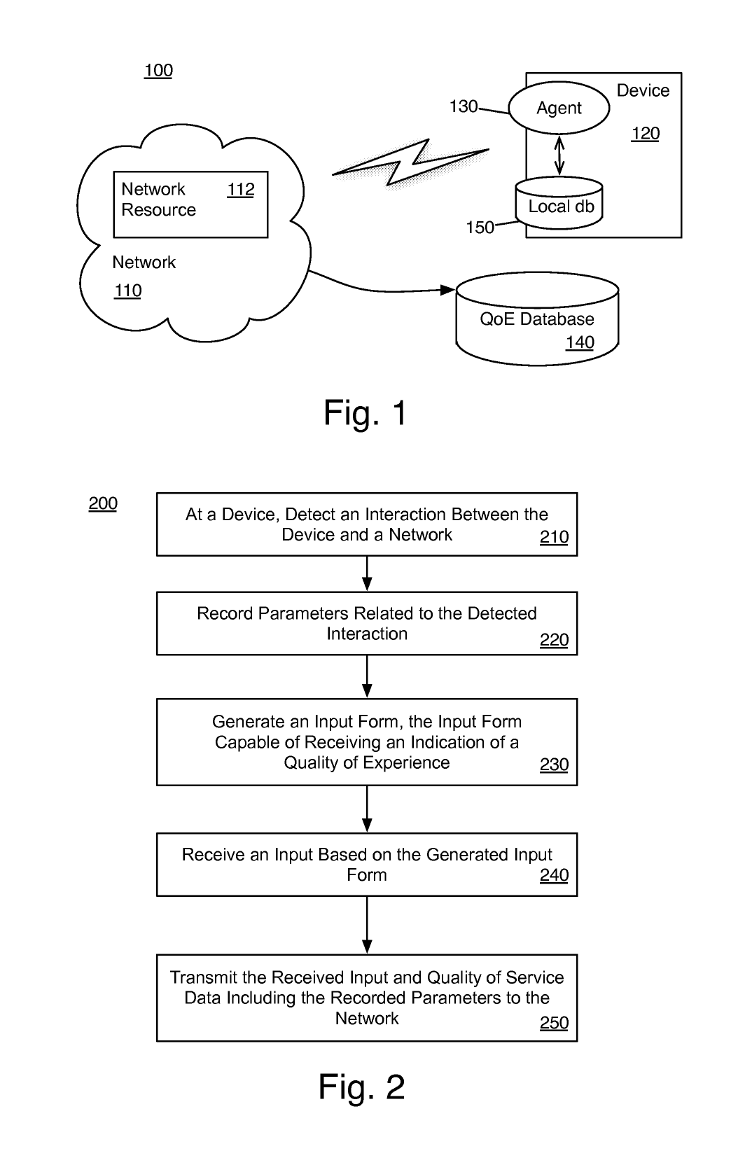

FIG. 1 illustrates a system for providing quality of experience data, arranged in accordance with at least some embodiments of the present disclosure. FIG. 1 shows a system 100 including a network 110 and a device 120. In some implementations, the network 110 may be a cellular network. In some implementations, the network 110 may be an Internet service provider network. In some implementations, the network 110 may be a satellite television network.

The device 120 (e.g., a smart phone, a tablet computer, a laptop computer, a desktop computer, or the like) may be used to connect to the network 110 and access services (e.g., voice calling, the Internet, network programming, or the like) provided by the network 110. As can be seen, FIG. 1 shows that the device 120 may connect to the network 110 wirelessly. This may be facilitated using various wireless protocols (e.g., GSM, CDMA, LTE, 802.11, Bluetooth, or the like). Alternatively, although not shown in FIG. 1, the device 120 may connect to the network 110 using another type of connection (e.g., a coaxial cable connection, a fiber optic connection, a CAT5 connection, or the like). Furthermore, although also not shown in FIG. 1, a combination of connections may be used for the device 120 to connect to the network 110. For example, a combination of wired and wireless connections, using various connection protocols, may be used.

As stated, a user (e.g., a customer of the network 110, or the like) may interact with the network 110 through the device 120. The user's perceptions of these interactions with the network 110 (e.g., in the form of QoE data) may be provided according to various implementations of the present disclosure. For example, the network 110 may be a cellular network. Furthermore, the device 120 may be a tablet computer capable of wirelessly connecting to the network 110. As such, the device 120 may be used to interact (e.g., send/receive text messages, access video chatting services, access the Internet, access an application store, or the like) with the network 110. Accordingly, the user's perceptions of these interactions may be provided.

FIG. 1 shows the system 100 further including an agent 130. In various implementations, the agent 130 may be a software application executable on the device 120. In some implementations, the operator of the network 110 may provide the agent 130. For example, a network resource 112 (e.g., an application, a virtual machine, a computer, or the like) may transmit the agent 130 to the device 120. In some implementations, a user of the device 120 may decide to install the agent 130 voluntarily. In alternative implementations, a third-party may provide the agent 130. For example, in some implementations, a third-party may desire to collect QoE data related to a customer's interactions with the network 110. Accordingly, the third-party may then provide the agent 130 for this type of purpose.

The agent 130 may facilitate providing QoE data, according to various embodiments of the present disclosure. The agent 130 may be used to provide QoE data related to a user's interaction with the network 110. In various examples, which will be further detailed below, the agent 130 may collect QoE data related to an interaction between the user (e.g., utilizing the device 120, or the like) and the network 110. The QoE data may then be transmitted to the network 110, by for example, transmitting the QoE data to the network resource 112. In general, the agent 130 may record QoS data during an interaction between the device 120 and the network 110. Then, the agent 130 may generate an input form capable of receiving from the user an indication of a quality of experience related to the interaction. The agent 130 may then transmit the QoS data and an indicated quality of experience to the network resource 112.

In some examples, the provided QoE data may be stored in a database. For example, FIG. 1 shows the system 100 including a QoE database 140. Accordingly, the QoE database 140 may store the QoE data related to interactions with the network 110. In general, the QoE database 140 may be implemented from any available database structure. Furthermore, the QoE database 140 may be implemented using any combination of database standards, such as, for example, SQL, ODBC, or the like. The QoE database 140 may follow any available database model, such as, for example, relational, object, relational-object, hierarchical, or the like, and may have any suitable schema. Furthermore, the QoE database 140 may be implemented using a computer, a server, multiple computers and/or servers networked together, a machine readable storage medium, or the like. The QoE database 140 may be hosted on the same computing resources as the network 110. Alternatively, the QoE database 140 may be hosted on different computing resources. For example, the QoE database 140 may be hosted by a cloud-based database provider.

Furthermore, with some embodiments of the disclosed technology, the system 100 may include a database 150, which may be local to the device 120. The agent 130 may then store data (e.g., QoE data, QoS data, both QoE and QoS data, or the like) in the local database 150. For example, in some implementations, the agent 130 may store QoS data related to an interaction between the device 120 and the network 110 in the local database 150 prior to transmitting the QoS data to the network 110. In further implementations, the agent 130 may generate the input form detailed above based at least in part upon data stored in the local database 150. Furthermore, in some embodiments, the agent 130 may prepopulate an indication of quality of experience referenced in the input form based on the stored data.

It is to be appreciated that although the system 100 may be described with respect to a single device 120, in practice multiple devices 120 may connect to the network 110. As such, various examples of the present disclosure may be provided to collect QoE data from one or more of these multiple devices.

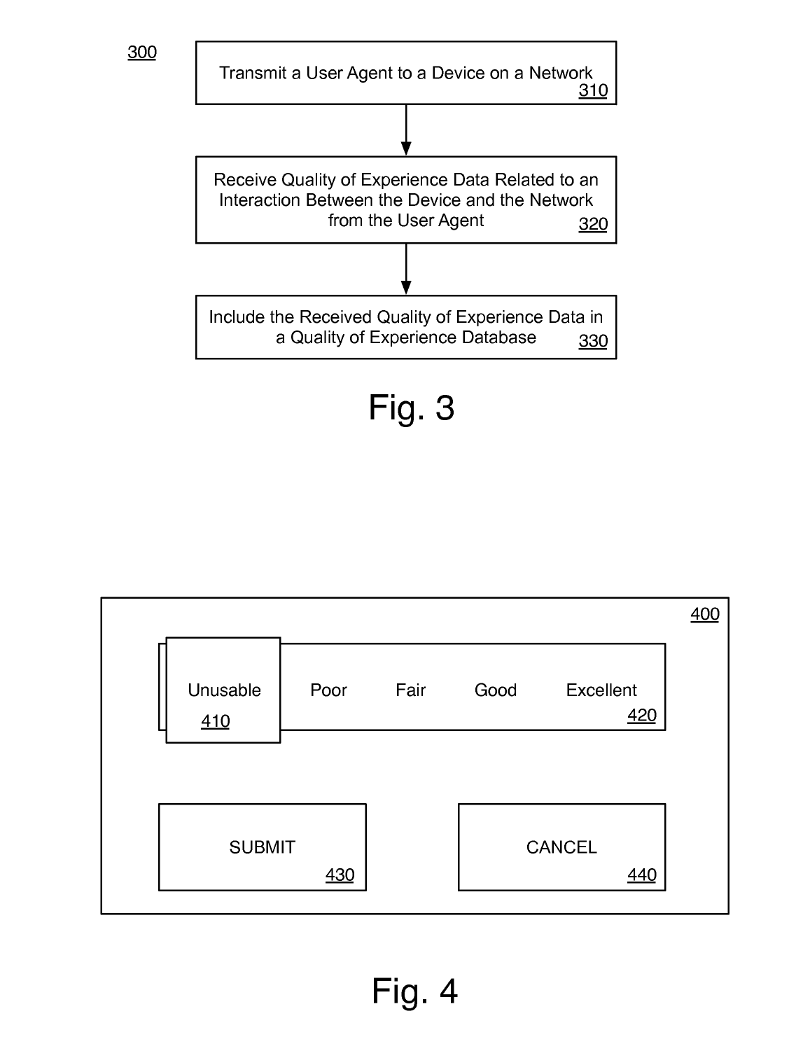

FIGS. 2-3 illustrate flow charts of example methods for providing QoE data, arranged in accordance with various implementations of the disclosed subject matter. In some portions of the description, illustrative implementations of the methods are described with reference to elements of the system 100 shown in FIG. 1. However, the described embodiments are not limited in these respects. That is, some elements shown in FIG. 1 may be omitted from example implementations of the methods detailed herein. Furthermore, other elements not depicted in FIG. 1 may be used to implement example methods.

FIGS. 2-3 employ block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

FIG. 2 illustrates an example method 200 for providing QoE data, arranged in accordance with various embodiments of the present disclosure. Beginning at block 210 (“at a device, detect an interaction between the device and a network”), the agent 130 may include logic and/or features configured to detect an interaction between the device 120 and the network 110. In general, the agent 130 may detect when the device 120 connects to the network 110 in order to access services. For example, if the device 120 connected to the network 110 to make a cellular phone call, the agent 130 may detect the interaction.

In various implementations, the agent 130 may detect and act on all interactions (e.g., all text messages, all phone calls, all data access requests, or the like) between the device 120 and the network 110. In various implementations, the agent 130 may act on only certain interactions (e.g., only phone calls, only text messages, only data access requests, or the like) between the device 120 and the network 110. In various implementations, the agent 130 may act on fewer than all interactions (e.g., one interaction per hour, one interaction per day, one interaction per week, or the like) between the device 120 and the network 110.

In some implementations, the agent 130 may be invoked by a user. More specifically, at block 210, the agent 130 may detect a request (e.g., from a user, or the like) to report on a particular interaction. With some embodiments, the request may identify the interaction. With some embodiments, the agent 130 may identify the interaction based in part on the received request.

Continuing from block 210 to block 220 (“record parameters related to the detected interaction”), the agent 130 may include logic and/or features configured to record parameters related to the detected interaction between the device 120 and the network 110. In general, the agent 130 may record available QoS data (e.g., call drop, delay, blocking, jitter, available bandwidth, echo, or the like) during an interaction between the device 120 and the network 110. For example, the agent 130 may record performance parameters (e.g., jitter, packet delay, available bandwidth, or the like) while a user is video chatting with the device 120 over the network 110. As an alternate example, the agent 130 may record performance parameters (e.g., signal strength, cutoff, time to connect, blocking, echo, or the like) while a user is making a voice call with the device 120 over the network 110.

In some examples, the agent 130 may record other statistics (e.g., application(s) used, URL(s) visited, web searches made, GPS coordinates, or the like) related to an interaction between the device 120 and the network 110. For example, QoS data related to a data access request between the device 120 and the network 110 may also include the URL or web search related to the data access request and the GPS location of the device 120 at the time of the request.

Continuing from block 220 to block 230 (“generate an input form, the input form capable of receiving an indication of a quality of experience”), the agent 130 may include logic and/or features configured to generate an input form capable of receiving an indication of a quality of experience related to the detected interaction. In general, the agent 130 may generate a form that a user of the device 120 may use to indicate the quality of the experience while interacting with the network 110. For example, the agent 130 may generate an input form with a slider for selecting a level of quality of experience and a submit button.

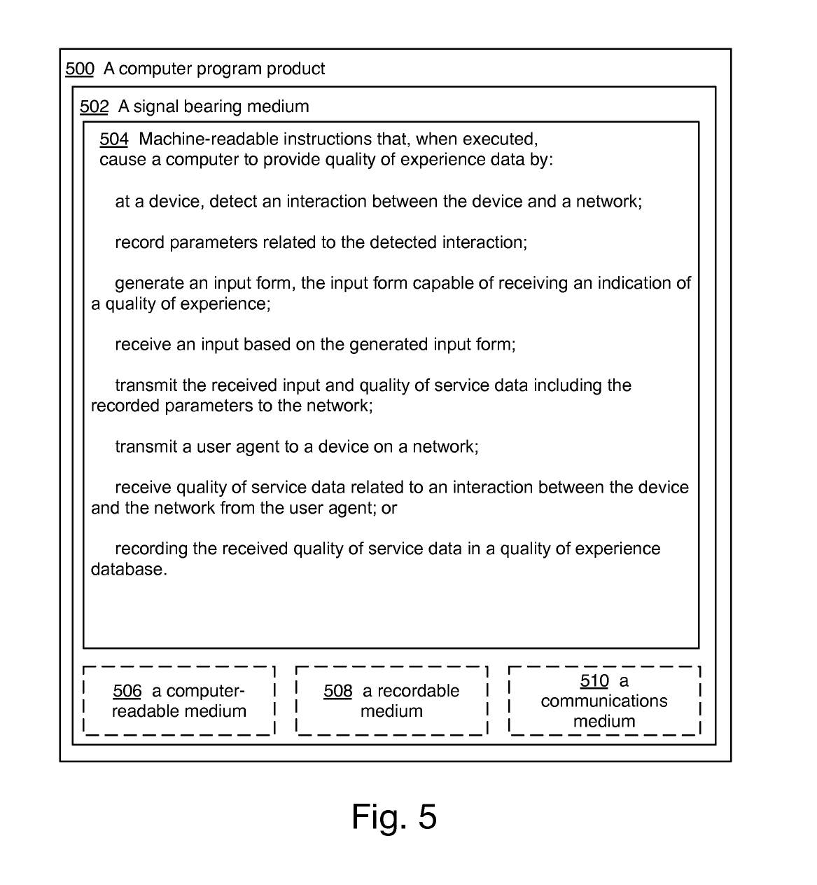

FIG. 4 shows an example input form 400 arranged in accordance with various embodiments of the disclosed technology. In general, the input form 400 may be used in conjunction with gathering QoE data for a device with a touch-sensitive surface over a display screen (e.g., smartphone, tablet device, or the like). As can be seen, the input form 400 may have a slider 410 for selecting a quality of experience 420. As can be further seen, in this example, the quality of experience 420 may have a scale of unusable, poor, fair, good and excellent. However, in other examples, the quality of experience 420 may have a different scale, such as, for example, “1, 2, 3, 4” or “Bad, Good, Best”. In some examples of the disclosed technology, the generated input form may use other options (e.g., check boxes, text boxes, drop down boxes, or the like, and/or additional screens as described below) to facilitate selecting a quality of experience.

The form 400 additionally may show a submit button 430 and a cancel button 440. In some embodiments of the present disclosure, once the user selects the level of quality experience 420 using the slider 410, the form 400 will not record the level until the submit button 430 is selected. In some embodiments, the slider 410 may act as the submit button. For example, once the slider 410 is selected (e.g., moved, touched, activated, or the like) the selected quality of experience 420 may be submitted. Alternatively, after a specified amount of time has elapsed, the selected quality of experience 420 may be submitted automatically. In some embodiments, the user may elect to cancel the submission, for example, by selecting the cancel button 440.

In some embodiments, the agent 130 may prepopulate one or more available selections in the generated form. Using FIG. 4 as an example, the agent 130 may preposition the slider 410 on a quality of experience 420 (e.g., “fair”, “good”, or the like) based on prior selections. In some implementations, data stored in the local database 150 may be used with the measured quality of service parameters to determine the quality of experience 420 selection on which to preposition the slider 410. With some examples, the agent 130 may use techniques (e.g., statistical analysis, artificial intelligence, machine learning, or the like) to assist in prepopulating the generated input form. In some implementations, the agent 130 may receive certain parameters from the network 110, either at block 230 or in advance, to assist in calculations on which the prepopulating may be based.

In some embodiments, the generated input form may allow for feedback related to multiple aspects of the quality of experience. For example, for voice calls, the generated input form may allow feedback on a variety of aspects (e.g., time to connect, speech quality, dropouts, or the like) of the quality of experience. In some embodiments, the generated input form may allow feedback on an overall quality of experience and then optionally, (e.g., if the user elects, if the selected quality of experience is less than a certain level, or the like) allow feedback on other aspects and/or details of the quality of experience. In some embodiments, the generated input form may include multiple screens to facilitate collecting feedback on other aspects of the quality of experience.

It is to be appreciated that the form 400 shown in FIG. 4 is presented for illustrative purposes only and is not intended to be limiting. Those of ordinary skill in the art will appreciate that variations of the input form 400 or other input forms not shown may be generated at block 230. For example, at block 230, the agent 130 may generate a form that includes visual and audio cues. Furthermore, the generated form may be configured to receive input in a variety of ways (e.g., audio input, tilting or shaking the device, or the like). These various inputs may be interpreted using, for example, speech recognition, accelerometers, or the like. For example, the user may adjust the slider by tilting the device and then submit the form by shaking the device. As will be appreciated, a combination of various techniques for presenting an input form to a user and receiving an input from the user may be utilized to minimize the intrusiveness of collecting the customer's response. In some embodiments, the techniques used to collect input may vary depending upon the device. For example, a smart phone may utilize the tilting and shaking example given above while a tablet computer may utilize the touch screen example. Additionally, in some embodiments, one or more aspects (e.g., method of receiving input, default selections, or the like) of the generated form may be configurable by a user.

Continuing from block 230 to block 240 (“receive an input based on the generated input form”), the agent 130 may include logic and/or features configured to receive user input based on the generated input form. In general, the agent 130 may receive input from the generated form (e.g., corresponding to the user selected level of satisfaction, or the like). In some embodiments, the agent 130 may store the received input in the local database 150.

Continuing from block 240 to block 250 (“transmit the received input and the quality of service data including the recorded parameters to the network”), the agent 130 may include logic and/or features configured to transmit the recorded QoS data and the received input to the network 110. In general, the agent 130 may transmit (e.g., via SMS messages, via an Internet connection, via a data connection, or the like) the recorded QoS data and the received input to the network 110. With some implementations, the agent 130 may transmit the recorded QoS data and the received input to the network resource 112. In some implementations, the agent 130 may add (e.g., upload, insert, or the like) the recorded QoS data and the received input to the QoE database 140.

FIG. 3 illustrates an example method 300 of a view from the network of providing QoE data, arranged in accordance with various embodiments of the present disclosure. Beginning at block 310 (“transmit a user agent to a device on a network”), the network resource 112 may include logic and/or features configured to transmit the agent 130 to the device 120. In some implementations, the network resource 112 may cause the device 120 to install the agent 130. In some implementations, the device 120 may include the agent 130 (e.g., by pre-installation during manufacture, or the like). As such, the network resource 112 may be configured to update or provision the agent 130 for use on the network 110. In some implementations, as indicated above, a user may elect to install the agent 130. As such, the network resource 112 may be configured to provide the necessary files to install the agent 130 on the device 120. For example, the network resource 112 may be part of an application store available on the network 110.

Continuing from block 310 to block 320 (“receive quality of experience data related to an interaction between the device and the network from the user agent”), the network resource 112 may include logic and/or features configured to receive QoE data related to an interaction between the device 120 and the network 110. In general, the network resource 112 may receive recorded QoE data from the agent 130. For example, as detailed above in conjunction with FIG. 2, the agent 130 may transmit QoE data (including recorded QoS parameters) to the network 110. Accordingly, in some examples, the network resource 112 may receive the QoE data from the agent 130. For example, the network resource 112 may receive an SMS message containing the QoE data from the agent 130.

Continuing from block 320 to block 330 (“include the received quality of experience data in a quality of experience database”), the network resource 112 may include logic and/or features configured to add the received QoE data to the QoE database 140. In general, the network resource 112 may add (e.g., upload, insert, or the like) the received QoE data to the QoE database 140.

In general, the methods described with respect to FIGS. 2-3 and elsewhere herein may be implemented as a computer program product, executable on any suitable computing system, or the like. For example, a computer program product for providing QoE data may be provided. Example computer program products may be described with respect to FIG. 5 and elsewhere herein.

FIG. 5 illustrates an example computer program product 500, arranged in accordance with at least some embodiments of the present disclosure. Computer program product 500 may include a machine readable non-transitory medium having stored therein a plurality of instructions that, when executed, operatively enable QoE data to be provided (e.g. by an agent, a network resource, or the like) according to the processes and methods discussed herein. Computer program product 500 may include a signal bearing medium 502. Signal bearing medium 502 may include one or more machine-readable instructions 504, which, when executed by one or more processors, may operatively enable a computing device to provide the functionality described herein. In various examples, some or all of the machine-readable instructions may be used by the devices discussed herein.

In some examples, the machine-readable instructions 504 may include at a device, detecting an interaction between the device and a network. In some examples, the machine-readable instructions 504 may include recording parameters related to the detected interaction. In some examples, the machine-readable instructions 504 may include generating an input form, the input form capable of receiving an indication of a quality of experience. In some examples, the machine-readable instructions 504 may include receiving an input based on the generated input form. In some examples, the machine-readable instructions 504 may include transmitting the received input and quality of service data including the recorded parameters to the network. In some examples, the machine-readable instructions 504 may include transmitting a user agent to a device on a network. In some examples, the machine-readable instructions 504 may include receiving quality of service data related to an interaction between the device and the network from the user agent. In some examples, the machine-readable instructions 504 may include recording the received quality of service data in a quality of experience database.

In some implementations, signal bearing medium 502 may encompass a computer-readable medium 506, such as, but not limited to, a hard disk drive, a Compact Disc (CD), a Digital Versatile Disk (DVD), a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

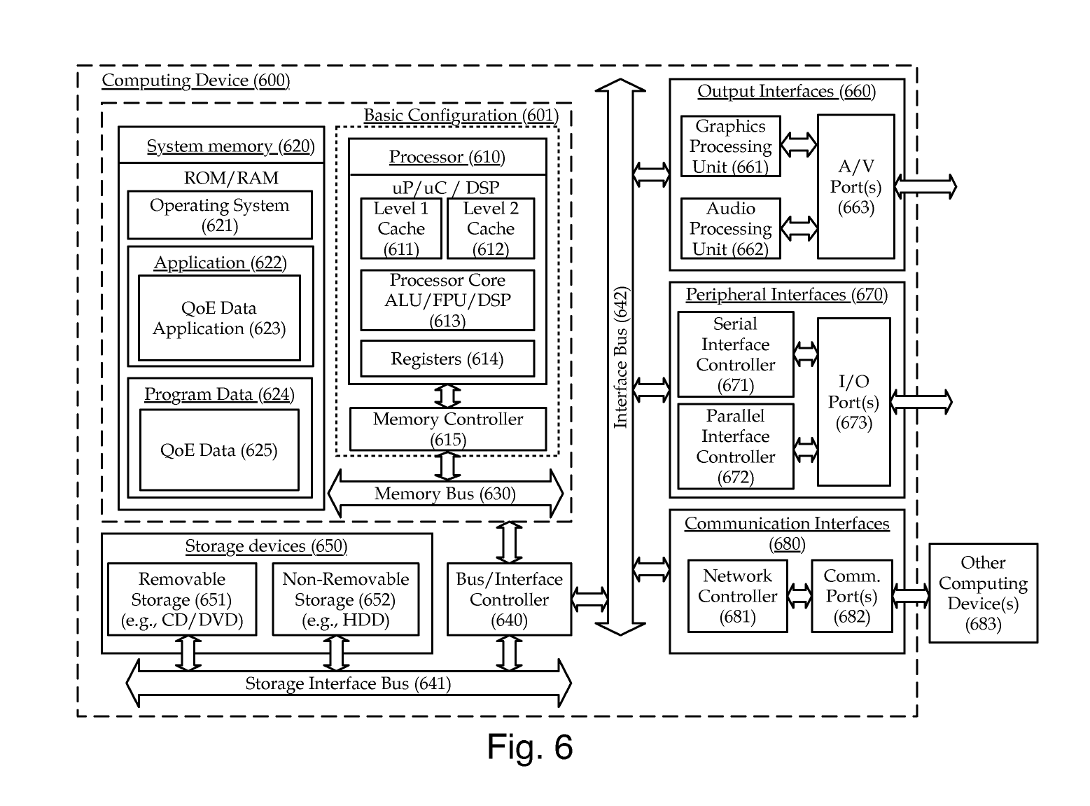

In general, the methods described with respect to FIGS. 2-3 and elsewhere herein may be implemented in any suitable server and/or computing system. Example systems may be described with respect to FIG. 6 and elsewhere herein. In general, the computer system may be configured to provide QoE data.

FIG. 6 is a block diagram illustrating an example computing device 600, arranged in accordance with at least some embodiments of the present disclosure. In various examples, computing device 600 may be configured to provide QoE data as discussed herein. In one example of a basic configuration 601, computing device 600 may include one or more processors 610 and a system memory 620. A memory bus 630 can be used for communicating between the one or more processors 610 and the system memory 620.

Depending on the desired configuration, the one or more processors 610 may be of any type including but not limited to a microprocessor (μP), a microcontroller (μC), a digital signal processor (DSP), or any combination thereof. The one or more processors 610 may include one or more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. A memory controller 615 can also be used with the one or more processors 610, or in some implementations the memory controller 615 can be an internal part of the processor 610.

Depending on the desired configuration, the system memory 620 may be of any type including but not limited to volatile memory (such as RAM), non-volatile memory (such as ROM, flash memory, etc.) or any combination thereof. The system memory 620 may include an operating system 621, one or more applications 622, and program data 624. The one or more applications 622 may include QoE data application 623 that can be arranged to perform the functions, actions, and/or operations as described herein including the functional blocks, actions, and/or operations described herein. The program data 624 may include QoE data 625 for use with QoE data application 623. In some example embodiments, the one or more applications 622 may be arranged to operate with the program data 624 on the operating system 621. This described basic configuration 601 is illustrated in FIG. 6 by those components within the dashed line.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The one or more data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 620, the removable storage 651 and the non-removable storage 652 are all examples of computer storage media. The computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 642 for facilitating communication from various interface devices (e.g., output interfaces, peripheral interfaces, and communication interfaces) to the basic configuration 601 via the bus/interface controller 640. Example output interfaces 660 may include a graphics processing unit 661 and an audio processing unit 662, which may be configured to communicate to various external devices such as a display or speakers via one or more A/V ports 663. Example peripheral interfaces 670 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 683 over a network communication via one or more communication ports 682. A communication connection is one example of a communication medium. The communication media may typically be embodied by computer readable instructions, data structures, program modules, or other data in modulated data signals, such as carrier waves or other transport mechanisms, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 600 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 600 may also be implemented as a personal computer including both laptop computer and non-laptop computer configurations. In addition, the computing device 600 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. These storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or one or more hard drives.

There is little distinction left between hardware and software implementations of aspects of systems; the use of hardware or software is generally (but not always, in that in certain contexts the choice between hardware and software can become significant) a design choice representing cost vs. performance tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed is paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for providing quality of experience information comprising:
at a device, detecting an interaction with a network;
recording parameters related to the detected interaction between the device and the network;
generating an input form, the input form capable of receiving an indication of a quality of experience;
receiving at least one input based at least in part on the generated input form; and
transmitting the at least one received input and quality of service data including at least a portion of the recorded parameters.

2. The method of claim 1, further comprising:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input;
receiving at least one second input based at least in part on the second generated input form; and
transmitting the at least one received second input and second quality of service data including at least a portion of the recorded second parameters.

3. The method of claim 1, wherein the input form comprises at least one prepopulated quality of experience response.

4. The method of claim 1, wherein the input form comprises at least one prepopulated quality of experience response, the prepopulated quality of experience response based at least in part on at least one of the recorded parameters.

5. The method of claim 1, wherein the input form comprises at least one prepopulated quality of experience response and an option for the user to accept the quality of experience input form without change.

6. The method of claim 1, further comprising:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input; and
receiving at least one second input based at least in part on the second generated input form, wherein the quality of experience data includes at least a portion of the second recorded parameters and the at least one second received input.

7. The method of claim 1, wherein the network comprises a cellular network.

8. The method of claim 1, wherein the parameters comprise at least one of a location of the device, a time of the interaction, a time to connect to the network, a signal strength, a signal quality, an available bandwidth, a signal echo, a signal blocking, a network cutoff, a voice quality, a data download rate, a data upload rate, an application executing during the interaction, or a website visited during the interaction.

9. The method of claim 1, wherein a content of the input form is based at least in part on an interaction type of the interaction of the network.

10. The method of claim 1, wherein the input form comprises at least one of a selection slider for selecting a quality of experience input or a grid of single selection buttons each indicating a quality of experience score or qualitative quality of experience descriptor.

11. The method of claim 1, wherein the interaction comprises at least one of a voice call, a web surfing, a file download, or a streaming medium.

12. A method for providing quality of experience information comprising:
transmitting a user agent to a plurality of devices on a network, wherein the user agent is configured to:
record parameters related to an interaction between the device and the network;
generate an input form;
receive at least one input based at least in part on the generated input form; and
transmit the at least one received input and quality of service data including at least a portion of the recorded parameters;
receiving a plurality of quality of experience data reports each from one of the plurality of devices; and
including each of the received quality of experience data reports in a quality of experience database.

13. The method of claim 12, further comprising:
transmitting the quality of experience database to a customer server.

14. The method of claim 12, further comprising:
analyzing the quality of experience database to determine a network improvement action based at least in part on the quality of experience database.

15. A device comprising:
a machine readable medium having stored therein instructions that, when executed, cause the device to provide quality of experience information by:
detecting an interaction with a network;
recording parameters related to the detected interaction between the device and the network;
generating an input form, the input form capable of receiving an indication of a quality of experience;
receiving at least one input based at least in part on the generated input form; and
transmitting the at least one received input and quality of service data including at least a portion of the recorded parameters; and
a processor coupled to the machine readable medium to execute the instructions.

16. The device of claim 15, wherein the machine readable medium has stored therein further instructions that, when executed, cause the device to provide the quality of experience information by:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input;
receiving at least one second input based at least in part on the second generated input form; and
transmitting the at least one received second input and second quality of service data including at least a portion of the recorded second parameters.

17. The device of claim 15, wherein the machine readable medium has stored therein further instructions that, when executed, cause the device to provide the quality of experience information by:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input; and
receiving at least one second input based at least in part on the second generated input form, wherein the quality of service data includes at least a portion of the second recorded parameters and the at least one second received input.

18. The device of claim 15, wherein the parameters comprise at least one of a location of the device, a time of the interaction, a time to connect to the network, a signal strength, a signal quality, an available bandwidth, a signal echo, a signal blocking, a network cutoff, a voice quality, a data download rate, a data upload rate, an application executing during the interaction, or a website visited during the interaction.

19. A machine readable non-transitory medium having stored therein instructions that, when executed, cause a device to provide quality of experience information by:
detecting an interaction with a network;
recording parameters related to the detected interaction between the device and the network;
generating an input form, the input form capable of receiving an indication of a quality of experience;
receiving at least one input based at least in part on the generated input form; and
transmitting the at least one received input and quality of service data including at least a portion of the recorded parameters.

20. The machine readable non-transitory medium of claim 19 having stored therein further instructions that, when executed, cause the device to provide the quality of experience information by:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input;
receiving at least one second input based at least in part on the second generated input form; and
transmitting the at least one received second input and second quality of service data including at least a portion of the recorded second parameters.

21. The machine readable non-transitory medium of claim 19 having stored therein further instructions that, when executed, cause the device to provide the quality of experience information by:
detecting a second interaction with the network;
recording second parameters related to the second detected interaction between the device and the network;
generating a second input form, the second input form capable of receiving a second indication of a quality of experience, wherein the second input form includes at least one prepopulated quality of experience response based on the at least one input; and
receiving at least one second input based at least in part on the second generated input form, wherein the quality of service data includes at least a portion of the second recorded parameters and the at least one second received input.

22. The machine readable non-transitory medium of claim 19, wherein the quality of experience input form comprises at least one of a selection slider for selecting a quality of experience input or a grid of single selection buttons each indicating a quality of experience score or qualitative quality of experience descriptor.

23. The machine readable non-transitory medium of claim 19, wherein the quality of experience input form is configured to receive audio input for selecting a quality of experience input indicating a quality of experience score or qualitative quality of experience descriptor.

24. A machine readable non-transitory medium having stored therein instructions that, when executed, cause a network to provide quality of experience information by:
transmitting a user agent to a plurality of devices on a network, wherein the user agent is configured to:
record parameters related to an interaction between the device and the network;
generate an input form;
receive at least one input based at least in part on the generated input form; and
transmit quality of service data including at least a portion of the recorded parameters and the at least one received input;
receiving a plurality of quality of experience data reports each from one of the plurality of user devices; and
recording each of the received quality of experience data reports in a quality of experience database.

25. The machine readable non-transitory medium of claim 23 having stored therein further instructions that, when executed, cause the network to provide the quality of experience information by:
transmitting the quality of experience database to a customer server.
The machine readable non-transitory medium of claim 23 having stored therein further instructions that, when executed, cause the network to analyze the quality of experience database to determine a network improvement action based at least in part on the quality of experience database.
